(19) United States
(12) Patent Application Publication
(10) Pub. No.: US 2012/0129403 A1
(43) Pub. Date: May 24, 2012

(54) ELECTRIC CONNECTOR

(75) Inventor: Hee-Kyoung Park, Seoul (KR)

(73) Assignee: SAMSUNG ELECTRONICS CO., LTD., Suwon-si (KR)

(21) Appl. No.: 13/300,429

(22) Filed: Nov. 18, 2011

(30) Foreign Application Priority Data
Nov. 18, 2010 (KR) 10-2010-0114887

(51) Int. Cl. H01R 24/28

(52) U.S. Cl. 439/660

(57) ABSTRACT

A plug connector includes a housing that includes a plurality of step jaws and terminals that are arranged interposing adjacent step jaws. The plug connector also includes one or more terminals disposed on one or more exposed surfaces of each step jaw.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Nov. 18, 2010 and assigned Serial No. 10-2010-0114887, the contents of which are herein incorporated by reference.

### TECHNICAL FIELD

The present disclosure relates to an electric connector. More particularly, the present disclosure relates to an electric connector that is light and slim while having several terminals.

### BACKGROUND

Currently, owing to the development of the electronic communication industry, portable terminals such as mobile communication terminals (i.e., cellular phones), electronic notes, Personal Digital Assistants (PDAs) and the like are becoming necessities to a modern society while becoming an important means for delivery of fast changing information. In these circumstances, the portable terminal is increasingly adding functions while striving to maintain lightness and slimness in size.

For example, portable terminals include socket connectors for connection with external devices such as earphones, electric chargers, memories and the like. The socket connectors ideally exhibit lightness, slimness and simplicity. Thus, there is a trend toward integrating all socket connectors into one connector to connect several devices to the portable terminal. In these circumstances, the socket connector bears a burden of having all contact terminals for several external devices. A plug connector connecting to the socket connector has the same burden as well.

### SUMMARY

To address the above-discussed deficiencies of the prior art, it is a primary aspect of the present disclosure to solve at least the above-mentioned problems and/or disadvantages and to provide at least the advantages described below. Accordingly, one aspect of the present disclosure is to provide an electric connector that exhibits lightness and slimness while having several terminals.

Another aspect of the present disclosure is to provide an electric connector whose locking force is improved.

The above aspects are achieved by providing an electric connector.

In accordance with an aspect of the present disclosure, a plug connector is provided. The plug connector includes a housing that includes a plurality of step jaws and terminals that are arranged interposing adjacent step jaws. The plug connector also includes one or more terminals disposed on one or more exposed surfaces of each step jaw.

According to another aspect of the present disclosure, a socket connector is provided. The socket connector includes a housing that includes a plurality of step jaws and terminals that are arranged interposing adjacent step jaws provided within a cavity. The socket connector also includes one or more terminals disposed on one or more exposed surfaces of each step jaw.

Before undertaking the DETAILED DESCRIPTION OF EXEMPLARY EMBODIMENTS below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present disclosure will become more apparent from the following detailed description when taken in conjunction with the accompanying drawings in which:

FIG. 1 illustrates a perspective diagram for a plug connector according to an embodiment of the present disclosure;

FIG. 2 illustrates a diagram for a structure of a plug connector according to an embodiment of the present disclosure;

FIG. 3 illustrates a diagram for a structure of a plug connector according to another embodiment of the present disclosure; and

FIG. 4 illustrates a diagram for a structure of a socket connector according to an embodiment of the present disclosure.

### DETAILED DESCRIPTION OF THE INVENTION

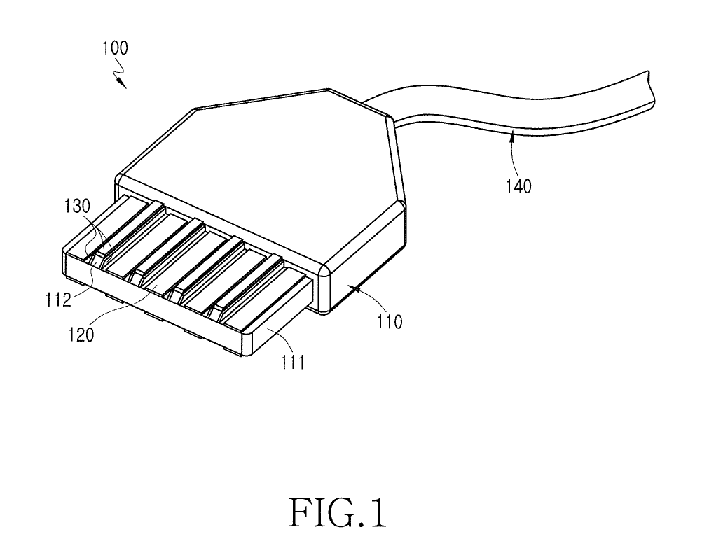

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged connector. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be different depending on user and operator's intention or practice. Therefore, the terms should be defined on the basis of the disclosure throughout this specification.

Exemplary embodiments of the present disclosure provide an electric connector and, more particularly, provide a technology for an electric connector that exhibits lightness and slimness while having several terminals.

In general, an electric connector is a combination of a socket connector and a plug connector, and may communicate a signal. For one example, a cellular phone includes a socket connector, and an external device (such as an earphone, an electric charger and the like) includes a plug connector. If the plug connector of the external device is fitted into the socket connector of the cellular phone, the two devices may communicate a signal with each other. Accordingly, in many cases, the plug connector and the socket connector each include a mutually corresponding terminal and structure. Thus, a description centering on the plug connector is made below.

FIG. 1 illustrates a perspective diagram for a plug connector according to an embodiment of the present disclosure.

Referring to FIG. 1, the plug connector 100 according to the embodiment of the present disclosure includes a housing 110, and a plurality of terminals 120 and 130 attached to the housing 110. The housing 110, which is an extruded plastic structure, supports and protects the terminals 120 and 130. Further, the housing 110 includes a protrusion 111 to which the terminals 120 and 130 are attached, and which is hereafter fitted into a socket connector.

The housing 110 includes step jaws 112 arranged at regular intervals at a top or bottom, and the terminals 120 are arranged interposing adjacent step jaws 112. The step jaws 112 enhance a locking force.

In an embodiment, at least one or more terminals 130 are further arranged on exposed surfaces of the step jaws 112 according, to the present disclosure. This is a solution to a burden of an electric connector having several terminals.

The terminals 120 and 130 are electrically connected to a cable 140.

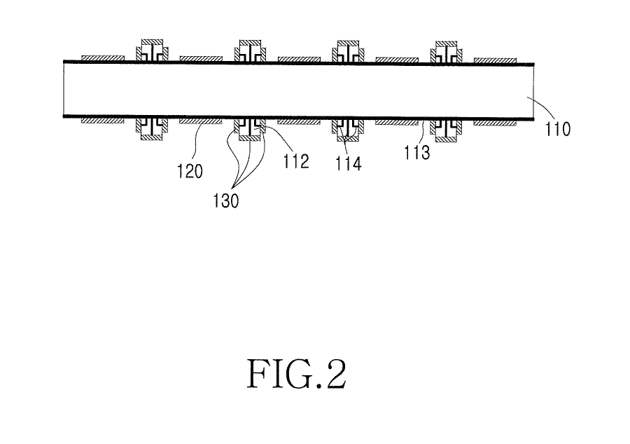

FIG. 2 illustrates a diagram for a structure of a plug connector according to an embodiment of the present disclosure.

Referring to FIG. 2, the terminals 120 and 130 are attached to the housing 110. The terminals 120 and 130 include the terminals 120 arranged interposing adjacent step jaws 112 and the terminals 130 arranged on the exposed surfaces of step jaws 112.

Each step jaw 112 includes at least two planes, and the terminals 130 can be attached to the planes. As illustrated in FIG. 2, each step jaw 112 includes three exposed planes, and a terminal 130 may be attached to each of the three exposed planes of the step jaw 112.

The housing 110 includes a Printed Circuit Board (PCB) 113 whose circuit pattern is constructed to match with the terminals 120 and 130, and the terminals 120 and 130 may connect to the circuit pattern through vias 114. Further, the terminals 120 and 130 may be soldered to the circuit pattern of the PCB 113. Additionally, the circuit pattern of the PCB 113 may be connected to a cable 140 illustrated in FIG. 1. The PCB 113 may be insert-molded into the housing 110.

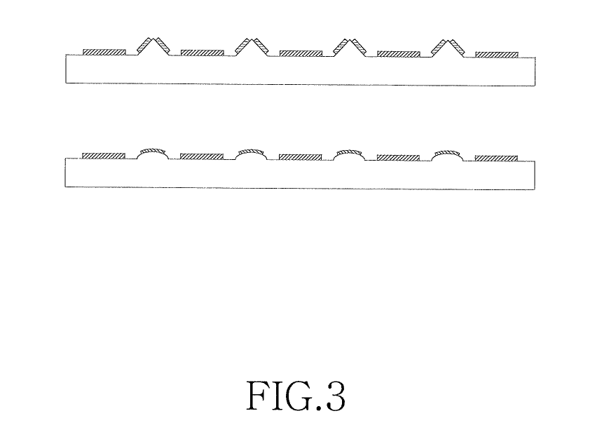

FIG. 3 illustrates a diagram for a structure of a plug connector according to another embodiment of the present disclosure.

Referring to FIG. 3, step jaws of a housing may be of various shapes. As illustrated, the step jaws may have a cross section shape such as a triangle shape, an arc shape and the like, and at least one or more terminals can be formed on exposed surfaces of the step jaw.

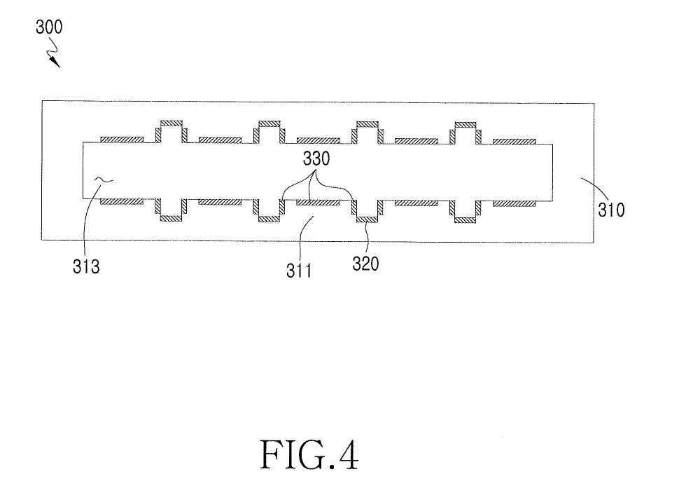

FIG. 4 illustrates a diagram for a structure of a socket connector according to an embodiment of the present disclosure. The socket connector has a structure arranged to fit with the plug connector.

Referring to FIG. 4, the socket connector 300 includes a housing 310 with a cavity 313 which the protrusion 111 of the plug connector 100 can be fitted into, and a plurality of terminals 320 and 330 provided on inner surfaces of the cavity 313 of the housing 310.

The housing 310 includes step jaws 311 at its inner top or bottom. The terminals can be divided into the terminals 320 arranged interposing adjacent step jaws 311 and the terminals 330 arranged on exposed surfaces of the step jaws 311. When the plug connector 100 is fitted into the socket connector 300, the terminals 320 are arranged to contact the terminals 130 of the plug connector 100. Likewise, the terminals 330 are arranged to contact the terminals 120 of the plug connector 100.

The housing 310 of the socket connector 300 includes a PCB whose circuit pattern is constructed to match with the respective terminals 320 and 330, and the respective terminals 320 and 330 can connect to the circuit pattern of the PCB by vias.

Further, the socket connector 300 is attached to a corresponding portable terminal, and the respective terminals 320 and 330 of the socket connector 300 can electrically connect with a main board of the portable terminal.

Furthermore, the respective terminals 320 and 330 of the socket connector 300 may connect to a corresponding cable.

Each step jaw 311 includes at least two or more planes, and the terminals 330 can be attached to the planes. As illustrated in FIG. 4, the terminals 330 can be attached to three exposed surfaces of each step jaw 311. This does not intend to limit the scope of the disclosure, and the step jaw 311 can be of various shapes. For one example, each step jaw 311 can be of a section shape such as a triangle shape, an arc shape and the like.

In conclusion, an electric connector according to the present disclosure can exhibit lightness and slimness while having several terminals.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A plug connector comprising:
a housing comprising a plurality of step jaws and terminals that are arranged interposing adjacent step jaws; and
one or more terminals disposed on one or more exposed surfaces of each step jaw.

2. The plug connector of claim 1, wherein the housing further comprises a printed circuit board (PCB) whose circuit pattern is constructed to correspond to the respective terminals, and
wherein the respective terminals electrically connect to the PCB.

3. The plug connector of claim 1, further comprising a cable configured to connect with the respective terminals.

4. The plug connector of claim 1, wherein each step jaw comprises at least two planes, and
wherein the terminals are attached to the planes of the each step jaw.

5. The plug connector of claim 1, wherein each step jaw has a rectangular cross section.

6. The plug connector of claim I, wherein each step jaw has a triangular cross section.

7. The plug connector of claim 1, wherein each step jaw has a cross section that includes an arc.

8. A socket connector comprising:
a housing comprising a plurality of step jaws and terminals that are arranged interposing adjacent step jaws provided within a cavity; and
one or more terminals disposed on one or more exposed surfaces of each step jaw.

9. The socket connector of claim 8, wherein the housing further comprises a printed circuit board (PCB) whose circuit pattern is constructed to correspond to the respective terminals, and
wherein the respective terminals electrically connect with the circuit pattern of the PCB.

10. The socket connector of claim 8, wherein the housing is attached to a corresponding portable terminal, and the respective terminals electrically connect with a main board of the portable terminal.

11. The socket connector of claim 8, further comprising a cable configured to connect with the respective terminals.

12. The socket connector of claim 8, wherein each step jaw comprises at least two planes, and
wherein the terminals are attached to the planes of the each step jaw.

13. The socket connector of claim 8, wherein each step jaw has a rectangular cross section.

14. The socket connector of claim 8, wherein each step jaw has a triangular cross section.

15. The socket connector of claim 8, wherein each step jaw has a cross section that includes an arc.

16. A system comprising:
a plug connector comprising:
a plug housing comprising a first plurality of step jaws and terminals that are arranged interposing adjacent step jaws; and
one or more terminals disposed on one or more exposed surfaces of each step jaw; and
a socket connector having a cavity configured to accept the plug connector, the socket connector comprising:
a socket housing comprising a second plurality of step jaws and terminals that are arranged interposing adjacent step jaws provided within the cavity; and
one or more terminals disposed on one or more exposed surfaces of each step jaw.

17. The system of claim 16, wherein the plug housing further comprises a printed circuit board (PCB) whose circuit pattern is constructed to correspond to the respective terminals, and
wherein the respective terminals electrically connect to the PCB.

18. The system of claim 16, wherein the plug connector further comprises a cable configured to connect with the respective terminals.

19. The system of claim 16, wherein each of the first and second step jaws comprises at least two planes, and
wherein the terminals are attached to the planes of the each step jaw.

20. The system of claim 16, wherein each of the first and second step jaws has a rectangular cross section.
